(19) United States
(12) Patent Application Publication
(10) Pub. No.: US 2018/0069455 A1
(43) Pub. Date: Mar. 8, 2018

(54) METHOD AND DEVICE FOR LIQUID COOLING OF ELECTRIC MOTOR

(71) Applicant: BAE Systems Hägglunds Aktiebolag, Örnsköldsvik (SE)

(72) Inventor: Daniel ENGBLOM, Bonässund (SE)

(73) Assignee: BAE Systems Hägglunds Aktiebolag, Örnsköldsvik (SE)

(21) Appl. No.: 15/559,804

(22) PCT Filed: Mar. 24, 2016
(86) PCT No.: PCT/SE2016/050247

§ 371 Date: Sep. 19, 2017

(30) Foreign Application Priority Data
Apr. 2, 2015 (SE) 1550408-7

(51) Int. Cl. H02K 9/193

(52) U.S. Cl. CPC H02K 9/193

(57) ABSTRACT

A device for liquid cooling an electric motor having a rotor and a stator includes at least one cooling liquid applicator arranged to apply cooling liquid from the side of the stator onto an end portion of the stator. The cooling liquid applicator is moveably arranged relative to the stator so that the cooling liquid by means of the movement of the cooling liquid applicator is applied onto different areas of the end portion. In this way a continuous stream of cooling liquid can be applied onto the end portion of the stator leading to a reduced risk for erosion of located coil ends.

### TECHNICAL FIELD

The invention relates to a device for liquid cooling of an electric motor according to the preamble of claim 1. The invention also relates to a method for liquid cooling of an electric motor according to the preamble of claim 20. The invention also relates to an electric motor comprising such device, and a motor vehicle comprising such electric motor.

### BACKGROUND

During operation electric motors are heated whereby cooling is required to divert the heat. Cooling of electric motors can be performed using different types of cooling medium such as for example air, water or oil.

In high performance electric motors cooling is extremely important in order to maintain performance. Cooling of active parts of the electric motor directly affects the performance. Hereby, liquid cooling using for example oil lead to effective cooling.

An important motor component having a large need for cooling is the stator of the electric motor and in particular the end portions of the stator encompassing the coil ends of the stator winding. For this reason many cooling devices are configured to apply a cooling medium onto the end portions of the stator and the thereby often exposed coil ends.

The stator winding often comprises a coated isolated conductor and a known problem of cooling devices wherein a liquid cooling medium is flushed directly onto the coil ends is erosion. The often statically applied stream of cooling liquid erodes the coating of the stator winding within the application surface which eventually risks damaging the motor.

This problem is generally solved by applying the cooling liquid in the form of a spray (aerosol particles) that is sprayed onto the stator winding and in particular its coil ends by the end portions of the stator instead of applying the cooling liquid in the form of a substantially flowing stream that strikes the same surface of the stator winding.

One such solution is for example described in GB 170946 wherein spray nozzles are arranged on the respective sides of the end portions of the stator and being configured to spray oil from the side onto the stator winding and its coil ends.

A problem with the cooling device in GB 170946 and other cooling device wherein cooling liquid is applied in the form of finely divided spray is the air mixture in the cooling liquid that inevitably arise. When the cooling liquid is to be regathered in order to later be pumped around in the cooling device for cooling and recycling after having been sprayed onto areas having a need for cooling, the high air content in the cooling liquid causes problems with pumping and control of fluid pressure. The high air content makes pumping and pressure control inefficient and imprecise.

### OBJECTS OF THE INVENTION

An object of the present invention is to provide a method and a device for liquid cooling of an electric motor that solves or at least alleviates one or more of the above mentioned problems associated with prior art cooling devices.

A particular object of the present invention is to provide a method and a device for liquid cooling of an electric motor facilitates simple and efficient cooling of the electric motor.

Another object of the present invention is to provide a method and a device for efficient liquid cooling of an electric motor that solves or at least alleviates the above mentioned problem regarding erosion of liquid cooled stator windings and un-desired air mixture of the cooling liquid.

### SUMMARY OF THE INVENTION

These and other objects, apparent from the following description, are achieved by a device and a method, of the type stated by way of introduction and which in addition exhibits the features recited in the characterising clauses of the appended claims 1 and 20. Furthermore, the objects are achieved by an electric motor according to claim 18 and a motor vehicle according to claim 19. Preferred embodiments of the device and method are defined in appended dependent claims 2-17 and 21-30.

According to an aspect these objects are achieved by a device for liquid cooling of an electric motor having a rotor and a stator. The cooling device comprises at least one cooling liquid applicator arranged to from the side of said stator apply cooling liquid, such as oil, onto an end portion of said stator-The cooling liquid applicator is moveably arranged relative to said stator so that the cooling liquid by means of the movement of the cooling liquid applicator is applied onto different areas of said end portion.

By means of arranging the cooling liquid applicator so that it moves relative to the stator upon application of cooling liquid the cooling liquid can be applied in the form of one or more streams which by means of the movement of the cooling liquid applicator strikes different areas of the end portions of the stator, whereby the problems with erosion as mentioned above can be avoided or at least largely alleviated. Furthermore, since the cooling liquid is flushed onto the end portion of the stator in the form of one or more streams, the air content of the cooling liquid is reduced compared to solutions wherein the cooling liquid is applied in the form of a spray, which avoids or at least alleviates the above mentioned problems with regard to pumping and pressure control of cooling liquid.

The cooling device is in particular intended to apply cooling liquid onto a stator winding comprised in the stator and in particular onto the coil ends of the stator winding, which in many configurations of electric motors are exposed by the end portions of the stator and often extending from these in the axial direction of the stator.

Herein the term cooling liquid applicator is intended as an element or device whose function is to eject cooling liquid onto motor components in need of cooling. Hereby cooling liquid applicator comprises some form of a body, which according to a preferred embodiment does not constitute part of any pre-existing motor component, such as rotor or stator, instead it constitutes a separate component of the cooling device of the electric motor, whereby the cooling liquid applicator typically has as its only function to eject cooling liquid onto motor components in need of cooling. In order to achieve the relative movement between the cooling liquid applicator and stator of the electric motor said body or portions thereof may be arranged to move relative to the stator during operation of the electric motor. The in relation to the stator moveable body or body portion comprises at least one outlet for ejection of cooling liquid, typically arranged in a nozzle of comprised in the cooling liquid applicator. Thus the cooling liquid applicator is configured such that at least one outlet arranged in the cooling liquid applicator for ejection of cooling liquid is moveably arranged in relation to the or those motor components intended to be cooled, which according to a preferred embodiment thus comprises the stator of the electric motor and in particular its end portion and the thereby arranged coil ends.

According to an embodiment of the cooling device said cooling liquid applicators are arranged at the side of the stator in its axial direction of extension, whereby the cooling liquid applicator is arranged to eject said cooling liquid in direction towards said end portion, for example by means of that a nozzle comprised in the cooling liquid applicator is at least partially directed towards said end portion.

According to an embodiment said cooling liquid applicator is rotatably arranged relative to said stator. Thereby efficient application of cooling liquid may be accomplished, for instance since the rotational movement of the rotor and/or the pressure of the cooling liquid may be used to accomplish said rotational movement. Further the centrifugal force caused by said rotational movement may be used to control the stream of cooling liquid that is ejected from the cooling liquid applicator. Thereby the striking path of the stream, i.e. the path along which the stream of cooling liquid strikes the end portion of the stator, may be controlled by means of controlling the rotational velocity of said rotational movement.

In an embodiment of the cooling device said cooling liquid applicator is rotatably arranged relative to said stator in such a fashion that the cooling liquid applicator ejects cooling liquid along a substantially circular path in a plane located at a distance from and substantially parallel with said end portion of the stator. Allowing the cooling liquid applicator to rotate along a circular path in a plane parallel with the plane onto which cooling liquid is to be applied is an efficient and for constructional reasons advantageous way of providing the cooling device with desired characteristics.

In an embodiment the cooling liquid applicator is arranged to rotate around an axis substantially coinciding with the rotor shaft of the electric motor. By means of selecting an axis of rotation coinciding with the rotor shaft of the electric motor the movement of the rotor shaft may be used for causing of rotational movement of the cooling liquid applicator. In addition since the stator and its end portion generally are arranged concentrically around the rotor and the rotor shaft, a symmetric construction may be provided. Apart from structural advantages this is beneficial since control of the striking path along the stator end for the stream of cooling liquid is facilitated.

According to an embodiment of the cooling device said cooling liquid applicator is arranged to be caused to rotate by means of a rotational movement of said rotor. This is an efficient and structural advantageous manner to accomplish suitable rotational movement of the cooling liquid applicator.

According to a variant of this embodiment the cooling liquid applicator is fixedly mounted on a to the rotor attached rotor shaft. By means of fixating the cooling liquid applicator on the rotor shaft, for example by means of in a suitable manner attaching it on the rotor shaft or allowing it to constitute an integrated part thereof, the rotor shaft is utilised to accomplish the rotational movement of the cooling liquid applicator. Thereby the cooling liquid applicator is arranged to rotate with the same rotational velocity as the rotor shaft which means that the rotational velocity of the cooling liquid applicator, for applications where the rotor shaft constitutes the driving shaft of the electric motor, is controlled by the engine speed of the electric motor. A drawback of this variant is that the engine speed of the electric motor not in all respects provides optimal rotational velocity for the cooling liquid applicator. For example the centrifugal force may upon high engine speed of the electric motor become so large that the stream of cooling liquid is ejected in a too straight radial direction and thereby completely or partly misses the areas of the end portions of the stator having a large need for cooling.

According to another variant of the embodiment in which the cooling liquid applicator is caused to rotate by means of the movement of the rotor the cooling liquid applicator is rotatably mounted journaled in bearings to said rotor shaft by means of a bearing configuration, in such a way that the cooling liquid applicator is caused to rotate by means of action of friction between the rotor shaft and the cooling liquid applicator, via said bearing configuration. In this way the cooling liquid applicator may rotate in relation to the rotor and its shaft and is thereby not forced to rotate with a rotational velocity corresponding to the speed of the electric motor. Instead the cooling liquid applicator may in this fashion be caused to rotate slower, equally fast or faster than the rotor shaft, whereby optimal stream pattern and thereby efficient cooling can be accomplished. The rotatable mounting journaled in bearings of the cooling liquid applicator to the rotor shaft thus provides that the rotation of the rotor shaft may be used to generate desired rotation of the cooling liquid applicator while it at the same time for example enables slower rotation of the cooling liquid applicator than the rotor shaft when the electric motor operates at high speeds.

According to an embodiment the cooling liquid applicator comprises a fan blade or similar element arranged to increase the air resistance when the cooling liquid applicator is caused to rotate. This results in the effect of increased turbulence inside the motor housing and thereby also in convection cooling of the electric motor and its components but also, at least for the embodiments in which the cooling liquid applicator is mounted journaled in bearing to the rotor shaft, to reduce the rotational velocity of the cooling liquid applicator in relation to the rotational velocity of the rotor shaft such that the cooling liquid applicator may be caused to rotate slower than the rotor when the electric motor is operating at high speeds.

In addition to or instead of said fan blade the cooling liquid applicator may be arranged to eject the cooling liquid obliquely forward and/or backwards in the direction of rotation of the cooling liquid applicator in order to affect the rotational velocity of the cooling liquid applicator by means of the de-accelerating and/or accelerating force that arises thereby. That the cooling liquid is ejected obliquely forward and/or backwards in the direction of rotation of the cooling liquid applicator means that the direction of ejection has at least a small directional component in a tangential direction of the circular path along which the cooling liquid applicator rotates.

For embodiment wherein the cooling liquid applicator is configured to eject the cooling liquid in such oblique direction the cooling liquid applicator may further comprise a control unit configured to control the flow with which the cooling liquid is ejected from the cooling liquid applicator, to thereby control the rotational velocity of the cooling liquid applicator. This is typically performed based controlling the pressure of the cooling liquid based on measured pressure parameters, for example by means of control of a pump comprised in the cooling device. In this manner active control of the rotational velocity of the cooling liquid applicator is enabled.

Another way which offers control of the rotational velocity of the cooling liquid applicators is active control of the direction in which the cooling liquid is ejected from the cooling liquid applicator. In addition to or instead of said above mentioned control of the flow of the ejection of the cooling liquid the cooling device may therefore comprise an ejection direction device configured to affect the rotational velocity of the cooling liquid applicator by means of control of the direction in which the cooling liquid is ejected from the cooling liquid applicator.

According to a variant the ejection direction device may comprise direction control means in the form of a pivotable nozzle constituting a portion of the cooling liquid applicator, and a control unit configured to direct the nozzle in a direction in relation to the direction of rotation of the cooling liquid applicator that provides desired a de-accelerating or accelerating effect on the rotational velocity. In addition to or instead of said pivotable nozzle the ejection direction device may comprise direction control means in the form of at least one direction blade or similar element arranged in the flow path of the cooling liquid by the outlet of the cooling liquid applicator, typically arranged in a nozzle comprised in the cooling liquid applicator, and a control unit configured to direct said direction blade or similar element in a direction that provides desired effect on the rotational velocity of the cooling liquid applicator.

For embodiments where the cooling liquid applicator is mounted journaled in bearings to the rotor shaft the cooling device may advantageously be provided with a locking mechanism in order to if necessary prevent relative rotation between the cooling liquid applicator and the rotor shaft and thereby cause the cooling liquid applicator to rotate with the same rotational velocity as the rotor shaft. This may for example be desired when the electric motor is operating at low speeds.

According to a variant said locking mechanism comprises a locking ball or similar element, comprised in the rotor shaft, arranged to grip the cooling liquid applicator or a thereto attached element in order to thereby lock the cooling liquid applicator to the rotor shaft and prevent relative rotation there in between.

In the above described embodiments in which the cooling liquid applicator is fixed or rotatably mounted journaled in bearing to the rotor shaft of the electric motor said rotor shaft may advantageously comprise at least one cooling liquid conduit for supply of cooling liquid to said cooling liquid applicator. The cooling liquid conduit may advantageously at least be partially contained in said rotor shaft and for example be at least in part constituted by drill holes through said rotor shaft.

According to another embodiment the cooling liquid applicator is by no means mechanically attached to the rotor or the rotor shaft of the electric motor and do not utilise the rotation of the rotor for generation of its own movement relative to the end portion of the stator. Instead in this embodiment, the cooling liquid applicator is mounted rotatably journaled in bearing to a component being stationary relative to the stator, whereby the cooling liquid applicator is arranged to be caused to rotate at least partly and typically solely by means of ejection of cooling liquid in a direction obliquely backwards in relation to its intended direction of rotation, i.e. a direction with at least a small directional component in a tangential direction of the circular path along which the cooling liquid applicator is arranged rotate. The ejection of cooling liquid in this direction generates an opposite force on the cooling liquid applicator, which thereby is caused to rotate along said circular path.

Also in this embodiment the rotational velocity of the cooling liquid applicator, if required or desired, may be controlled by means of control of the flow with which the cooling liquid is ejected from the cooling liquid applicator and/or by means of control of the direction of ejection with which the cooling liquid is ejected from the cooling liquid applicator, as has been discussed above.

Also in this embodiment the rotational axis of the cooling liquid applicator is preferably substantially coinciding with the rotor shaft of the electric motor so as to achieve the above discussed symmetry and advantageous constructional solution. According to a variant the cooling liquid applicator in this embodiment is rotatably mounted journaled in bearings to a part of a motor housing that at least partly surrounds the electric motor. The motor housing houses at least the rotor and stator of the electric motor and at least portions of the cooling device according to the present invention, such as one or more cooling liquid applicators. Preferably the cooling liquid applicator in this embodiment is rotatably mounted journaled in bearing to an end wall of said motor housing. For example the cooling liquid applicator may be rotatably arranged on a circular and preferably ring shaped lip of said end wall that extends substantially perpendicularly from said end wall, in towards the centre of the motor housing. The cooling liquid applicator is thereby rotatably arranged in a plane substantially parallel with said end wall and substantially parallel with the end portion of the stator onto which it is arranged to apply cooling liquid, which plane is intermediate said end wall of the motor housing and said end portion of the stator. The circular lip is thus further preferably ring shaped, whereby the rotor shaft may be arranged to extend through said ring shaped lip and extend further through the end wall from which the lip extends into the motor housing, in order to thereby constitute an output drive shaft of the motor housing and the electric motor.

In the above described embodiment in which the cooling liquid applicator is rotatably mounted journaled in bearings to an end wall comprised in the motor housing said end wall is advantageously provided with a cooling liquid conduit for supply of cooling liquid to said cooling liquid applicator. The cooling liquid conduit may advantageously at least partly be comprised in said end wall and may for example at least partly be constituted by drill holes extending through said end wall.

The cooling device according to the present invention advantageously comprises at least two cooling liquid applicator arranged on opposite sides of said stator, in the axial direction of the stator, and configured to apply cooling liquid onto opposite ends of said stator.

The cooling device may advantageously be mirror symmetric around the diametrically extending centre axis of the rotor of the electric motor, at least with respect to how the cooling liquid applicators comprised in the cooling device are arranged around the rotor and the stator. Advantageously the cooling device is also mirror symmetric with respect to the placement and shaping of the cooling liquid applicators around the axially extending centre axis of the rotor of the electric motor.

In an embodiment the actual cooling liquid applicator is provided with a substantially circular hub portion configured to be caused to rotate around an axis of rotation, for example coinciding with the rotor shaft of the electric motor, and at least one or preferably more arms extending radially from the said hub portion. Each radially extending arm may hereby support a nozzle configured for ejection of cooling liquid from the cooling liquid applicator, preferably placed in the distant end of the arm opposite to the hub.

The cooling liquid applicator is arranged to apply cooling liquid onto the end portion of the stator in the form of a substantially continuous stream. This is opposite to applying the cooling liquid in the form of a spray. The cooling liquid applicator according to the invention, may thus be said to be arranged to flush cooling liquid onto the end portion of the stator, unlike spraying cooling liquid which is thus performed by many cooling devices according to prior art. In order to achieve a substantially coherent cooling liquid stream each cooling liquid stream is generally ejected from one and only one opening (outlet), unlike the cooling liquid spray that is sprayed using a spraying nozzle with many small openings according to prior art.

The cooling device according to the invention is specifically intended to be used with oil as cooling liquid but may advantageously be used with other cooling liquids.

According to another aspect of the present invention an electric motor is provided comprising a cooling device according to any of the above described embodiments.

According to yet another aspect of the present invention a motor vehicle is provided comprising such electric motor.

According to yet another aspect of the present invention a method for liquid cooling of an electric motor having a rotor and stator is provided. The method comprises the step of applying cooling liquid from the side of and onto at least one end portion of said stator by means of at least one cooling liquid applicator. The method further comprises the step of causing said cooling liquid applicator to move relative to said stator during the applicator of the cooling liquid so that the cooling liquid is applied onto different areas of said end portion.

The application of cooling liquid is advantageously performed by means of ejecting the cooling liquid towards said end portion by means of a cooling liquid applicator arranged by the side of the stator in its axial direction of extension, for example by means of a nozzle, for ejection of said cooling liquid, comprised in said cooling liquid applicator.

The step of causing the cooling liquid applicator to move advantageously comprises causing the cooling liquid applicator in rotary movement relative to said stator.

The method advantageously comprises the step of ejecting cooling liquid onto said end portion along a substantially circular path located at a distance from and substantially parallel with said end portion of the stator.

Furthermore, the cooling liquid applicator is advantageously caused to move in a rotary movement along an axis substantially coinciding with the rotor shaft of the electric motor.

According to an embodiment the cooling liquid applicator is caused to move rotary by means of a rotating movement of said rotor.

According to a variant the cooling liquid applicator is fixedly mounted on rotor shaft attached to the rotor, whereby the cooling liquid applicator is caused to rotate by means of rotation of said rotor shaft.

According to another variant the cooling liquid applicator is mounted journaled in bearings to the rotor shaft, whereby the cooling liquid applicator is caused to rotate by means of a friction action between the cooling liquid applicator and the rotor shaft, via the intermediate bearing configuration.

According to an embodiment the method comprises the step of by means of a fan blade or similar element arranged on the cooling liquid applicator, increasing the air resistance during rotation of the cooling liquid applicator in order to thereby reduce the rotational velocity of the cooling liquid applicator in relation to the rotational velocity of the rotor shaft.

The method may further comprise the step of upon need locking the cooling liquid applicator to the rotor shaft to prevent relative rotation there in between, so as to thereby cause the cooling liquid applicator to rotate with the same rotational velocity as the rotor shaft. This may for example be accomplished by means of causing a locking ball or similar element comprised in the rotor shaft to grip the cooling liquid applicator or a therewith fastened element so as to thereby lock the bearing configuration to the rotor shaft.

According to an embodiment application of cooling liquid may be performed by means of ejecting cooling liquid from the cooling liquid applicator in a direction obliquely forward and/or obliquely backwards in the direction of rotation of the cooling liquid applicator so as to by means of the de-accelerating and/or acceleration force arising thereby cause affect the rotational velocity of the cooling liquid applicator.

The method may further comprise the step of controlling the flow with which the cooling liquid applicator ejects the cooling liquid in said direction obliquely forwards and/or backwards so as to thereby control the rotational velocity of the cooling liquid applicator.

According to an embodiment in which the cooling liquid applicator by means of a bearing configuration is mounted rotatably journaled in bearing to a component being stationary relative to the stator the method may comprise the step of causing the cooling liquid applicator to rotate at least partly and preferably solely by means of ejecting cooling liquid in a direction obliquely backwards in the direction of rotation of the cooling liquid applicator.

Preferably the method comprises the step of applying cooling liquid onto opposite ends of said stator by means of at least two cooling liquid applicators arranged on the opposite sides of said stator.

According to an embodiment the method comprises the step of jointly applying a plurality of cooling liquid streams onto one and the same end portion of said stator during the rotational movement of said cooling liquid applicator by means of using a plurality of nozzles of one and the same cooling liquid applicator.

The method may comprise the step of controlling the direction of ejection in which the cooling liquid is ejected from the cooling liquid applicator so as to thereby control the rotational velocity of the cooling liquid applicator.

The method may comprise the further step of increasing the air resistance by means of a fan blade or similar element when the cooling liquid applicator is caused to move so as to thereby increase convection cooling of the electric motor and its components.

The step of applying cooling liquid onto the end portion of the stator is advantageously accomplished by means of flushing cooling liquid in a substantially continuous stream onto said at least one end portion. Advantageously the cooling liquid is flushed onto a stator winding comprised in the stator or more preferably onto the coil ends of the stator winding, located by said end portion.

As have been seen from the above description the invention is particularly intended for use with oil as cooling liquid, wherefore the step of applying cooling liquid onto the end portion of the stator advantageously comprises applying oil onto the said end portion.

More advantageous aspects of the cooling device, the electric motor, the motor vehicle and the method according to the present invention will be apparent from the hereinafter following detailed description.

### BRIEF DESCRIPTION OF THE DRAWINGS

A better understanding of the present invention will be had upon reference to the following detailed description when read in conjunction with the accompanying drawings, wherein like reference characters refer to like parts throughout the several views, and in which:

FIG. 1 schematically illustrates an embodiment of a motor vehicle according to an embodiment of the present invention;

FIG. 2 illustrates a side view of an axial cross section of an electric motor without cooling device;

FIG. 3A schematically illustrates a side view of an axial cross section of an electric motor with a device for liquid cooling of the electric motor according to a first embodiment of the present invention;

FIG. 3B schematically illustrates a side view of an axial cross section of an electric motor with a device for liquid cooling of the electric motor according to a variant of the first embodiment illustrated in FIG. 3A;

FIGS. 4A and 4B schematically illustrates a side view and a front view respectively of an embodiment of a cooling liquid applicator according to the invention;

FIGS. 5-7 schematically illustrates front views of other embodiments of a cooling liquid applicator according to the invention;

FIGS. 8A and 8B schematically illustrates side views of an axial cross section of an electric motor having a device for liquid cooling of the electric motor according to a second embodiment of the present;

FIG. 9 schematically illustrates a side view of an axial cross section of an electric motor with a device for liquid cooling of the electric motor according to a third embodiment of the present invention, and

FIG. 10 is a flow diagram illustrating a method for liquid cooling of an electric motor according to an embodiment of the present invention.

### DETAILED DESCRIPTION OF EMBODIMENTS

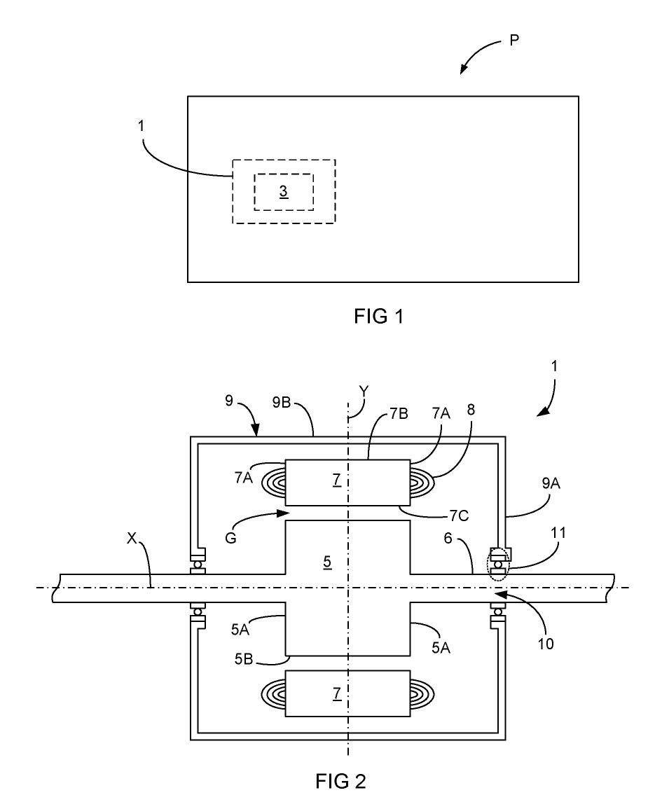

FIG. 1 shows a platform P comprising an electric motor 1 which comprises a cooling device 3 according to the present invention.

The platform P may comprise a motor vehicle such as a military vehicle, a utility vehicle, an automobile, a boat, a helicopter or another type of motor vehicle, provided with the electric motor 1. In an embodiment in which the electric motor 1 is comprised in a motor vehicle the electric motor 1 is configured for operation of said motor vehicle, which thereby constitutes an electrically driven vehicle. The cooling device 3 may be configured in accordance with any of the below described embodiments.

With reference to FIG. 2 some basic components of the electric motor 1 in FIG. 1 will here be described. FIG. 2 illustrates a side view of an axial cross section of the electric motor 1, without included cooling device 3.

The electric motor 1 comprises a rotor 5 and a stator 7, which are cylindrically shaped and concentrically arranged so that their respective centre axis substantially coincides with a centre axis X of the electric motor 1.

The rotor 5 has an envelope surface 5B facing the stator 7 and constituting what is herein referred to as the exterior surface of the rotor. The rotor also has end portions 5A constituting end portion of the cylinder shaped rotor 5. The electric motor 1 further comprises a rotor shaft 6 which is coupled to the rotor 5 and extending axially from at least one rotor end 5A. The rotor shaft 6 is generally also cylinder shaped and arranged concentrically with the rotor 5 and the stator 7 so that its centre axis coincides with the above mentioned centre axis X of the electric motor 1 or it may be, such as illustrated in FIG. 2, a double sided rotor shaft that extends from both sides of the electric motor 1.

During operation of the electric motor 1 the rotor 5 and thereby the rotor shaft is caused to rotate, whereby the rotor shaft 6 is arranged to transfer a driving torque outside of the electric motor to drive means (not shown), for example for propulsion of an electrically driven motor vehicle. The rotor 5 may according to a variant be constructed from stacked rotor plates, for example a plurality of on top of each other stacked rotor plates.

The stator 7 also has an envelope surface 7B and end portions 7A facing from the stator in its axial directions. The exemplified electric motor 1 is of an inner rotor type, meaning that the stator 7 is arranged to surround the rotor 5. The stator 7 thereby constitutes a cylindrical housing that surrounds the rotor 5 so that the envelope surface 5B of the rotor is completely surrounded by an interior surface or inner surface 7C of the stator 7 in the radial direction of the rotor. The exterior surface as well as envelope surface 5B of the rotor 5 is arranged nearby and separated from said inner surface 7C of the stator, whereby an air gap G is formed between the rotor 5 and the stator 7.

The stator 7 is according to a variant constructed from on top of each other stacked stator plates (not shown). The stator 7 comprises a stator winding, which may be constituted by a set of electrically conductive wires, preferably copper wires, through which a current is arranged to be conducted for operation of the electric motor 1. Said wires may be of the same of varying thickness and may also otherwise exhibit similar or varying characteristics. The wires are typically provided with an isolating surface layer, such as a thin layer of isolating lacquer forming an isolating film around each wire of the stator winding. The stator winding is typically arranged to extend axially along the stator 7 so that the winding is adjacent to the rotor 5. Further the stator winding is typically arranged to extend axially from the end portion for the stator 7A, turn outside of the end portions and be re-introduced through the end portion, whereby the portions extending axially from the stator forms so called coil ends 8.

The electrically conductive wires of the stator 7 is according to a variant arranged to extend axially in slots or apertures of said stator plates, whereby the different wire segments are arranged to be guided out from the end portions 7A of the stator 7 from a slot or aperture of the stator plates and back into a different slot or aperture of the stator plates.

The rotor 5 and the stator 7 constitute a central portion of the electric motor 1 and the physical unit which they jointly constitute will sometimes hereinafter be referred to as rotor/stator module. The rotor/stator module has a centre axis coinciding with the whole centre axis X of the electric motor, and an axial extension that coincides with the axial extension of the stator, which usually is somewhat longer than the axial extension of the rotor.

The electric motor 1 further comprises a motor housing 9 that surrounds the components comprised in the electric motor 1, including the rotor 5 and the stator 7. The motor housing 9 comprises wall portions 9A which surrounds the rotor/stator module in its axial directions, which wall portions hereinafter will be referred to as the end walls 9A of the motor housing, and wall portions 9B that surrounds the rotor/stator module in its axial directions and which hereinafter will be referred to as the envelope walls 9B of the motor housing. The motor housing may have an arbitrary shape but is generally cylinder shaped whereby the envelope walls 9B of the motor housing constitutes an envelope surface in the form of a cylindrical housing surrounding the envelope surface 7B of the stator, and wherein the end walls 9B of the motor housing constitutes substantially circularly shaped end walls of said cylindrical housing, which are arranged exteriorly and surrounds the end portions 5A, 7A of the stator.

The motor housing further comprises at least one opening 10 arranged in an end wall 9A through which the rotor shaft extends. The rotor shaft 6 is preferably rotatably mounted journaled in bearing in said opening by means of a bearing configuration 11, for example in the form of a ball bearing. When the electric motor 1 as in this embodiment is provided with a double sided rotor shaft 6 the motor housing is provided with such a rotor shaft opening 10 in each end wall 9A.

It should be noted that the electric motor 1 in FIG. 2 is mirror symmetric around its axial centre axis X and around a diametrical centre axis Y wherefore it should be realised that components which have not been provided with reference signs corresponds to the around these axis's mirror symmetrically arranged components.

With reference to the following drawings a cooling device according to the present invention will here be described. The cooling device is a device for liquid cooling of an electric motor and it will be described in the context of the exemplified electric motor 1 that has been described above with reference to FIG. 2. It shall however be realised that the cooling device according to the present invention may be used also in other types of electric motors and that the exemplified electric motor 1 therefore shall be regarded as one of many types of electric motors in which the cooling device according to the invention may be implemented in order to provide efficient cooling of components of electrical motors having a need for cooling.

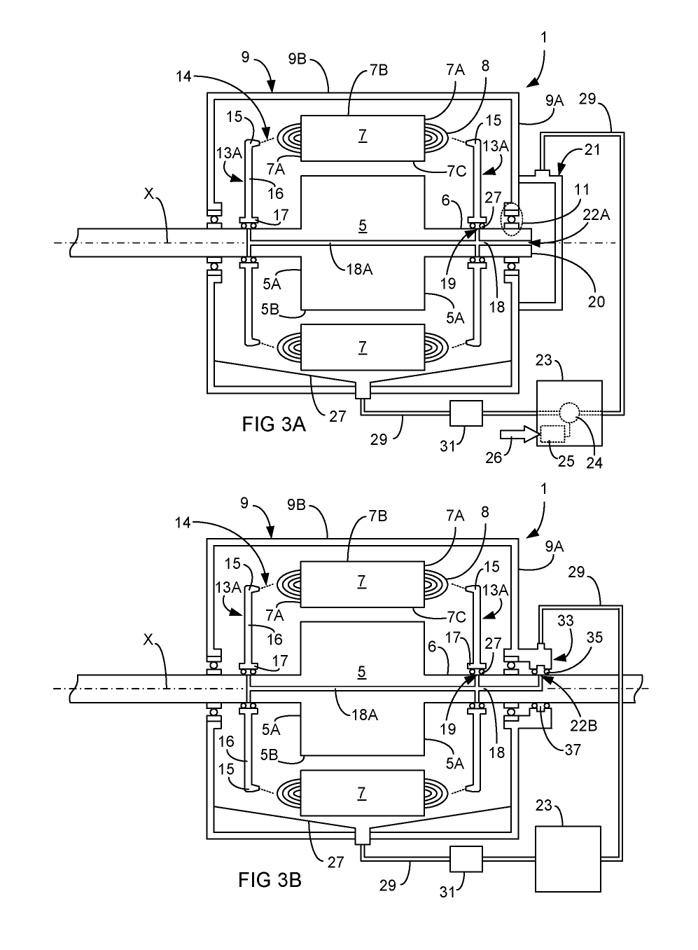

FIG. 3A illustrates a side view of an axial cross section of an electric motor substantially identical with the one that has been described above with reference to FIG. 2. Apart from the components that have been described above the electric motor 1 comprises a cooling device according to a first embodiment of the present invention.

The cooling device comprises two cooling liquid applicators 13, arranged on a respective side of the stator/rotor module and being arranged to apply cooling liquid 14 on a respective end portion 7A of the stator 7. In more detail the two cooling liquid applicators 13 are arranged on axially opposite sides of the stator and configured to eject cooling liquid onto a respective end portion 7A of the stator from axial axially exterior positions of the stator 7. More specifically each cooling liquid applicator 13 is arranged to flush cooling liquid in the form of a substantially continuous stream onto a respective coil end 8 of the stator winding, axially extending from a respective end portion end portion 7A of the stator.

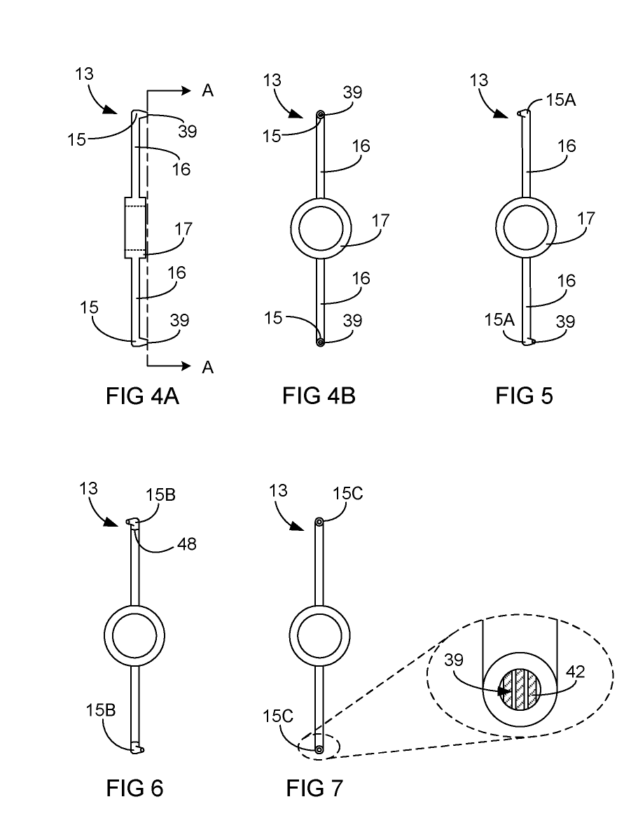

With simultaneous reference to FIGS. 4A and 4B each cooling liquid applicator 13 comprises at least one nozzle 15 for ejection of said cooling liquid 14, which nozzle is supported by an arm portion 16 that is attached to and radially extending from a substantially ring shaped hub portion 17 of the cooling liquid applicator 13. Each cooling liquid applicator 13 is arranged axially by the side of the stator 7 and is provided with a nozzle 15 arranged to eject cooling liquid in direction towards the end portion 7A of the stator and advantageously in direction towards the coil ends 8 of the stator winding.

As illustrated each cooling liquid applicator 13 is advantageously provided with at least two oppositely arranged arm portions 16, which extends radially towards opposite direction of said hub portion 17 and supports a respective nozzle 15 in the end extending from said hub portion 17. In this manner each cooling liquid applicator 13 is arranged to flush at least two substantially continuous streams of cooling liquid 14 onto an end portion 7A of the stator 7. In other embodiments (not shown) each cooling liquid applicator 13 may comprise more than two arms, radially extending from the hub portion 17, and supporting a respective nozzle, such as for example 3, 8 or 13 arms substantially symmetrically placed around the circumference of the hub portion and supporting a respective nozzle for ejection of cooling liquid.

With continued reference to FIG. 3A each cooling liquid applicator 13 is moveably arranged relative to the stator 7. In more detail each cooling liquid applicator 13 is preferably rotatably arranged relative to the stator 7. This is accomplished in this first embodiment by means of that the cooling liquid applicator 13 is coupled to the rotor shaft 6 of the electric motor in such a fashion that forces the cooling liquid applicator 13 to rotate with the rotor shaft 6. In the illustrated embodiment the cooling liquid applicator 13 is fixedly mounted to the rotor shaft 6. In this manned the cooling liquid applicators 13 are forced into rotation with a rotational velocity corresponding to the rotational velocity of the rotor shaft 6 and thus the speed of the electric motor 1. In this embodiment the hub portion 17 of the cooling liquid applicator 13 is fixedly mounted around the rotor shaft 6 so as to bring the cooling liquid applicator 13 into said rotation when the rotor shaft 6 rotates. In other embodiments (not shown) the hub portion 17 of the cooling liquid applicator 13 may be omitted which instead may comprise one or more arm portions 16 which are directly mounted on the rotor shaft 6.

The cooling liquid applicator 14 whose hub portion 17 is attached to the rotor shaft is thus arranged to rotate around the axial centre axis X of the rotor, which also is the centre axis of the stator and the entire electric motor. The nozzles 15 of the cooling liquid applicators 13 will thereby also rotate along circular paths being concentric with the stator in a plane, parallel to the end portion 7A of the stator, located at a distance therefrom, exterior to the stator in its axial direction. Thereby the stream of cooling liquid that is ejected from each nozzle 15 will, upon constant rotational velocity of the cooling liquid applicator 13 and during constant pressure of the cooling liquid, strike the end portion 7A of the stator along a circular path with a given radius from the centre axis X of the stator and the entire electric motor. The radius of the path along which the stream of cooling liquid strikes the stator end 7A or the from coil ends 8 extending therefrom, hereinafter referred to as the striking path, is controlled by for example the following parameters:
1) the radial distance of the nozzle 15 from the centre of rotation, i.e. the length of the arms 16 of the cooling liquid applicator 13,
2) the axial distance between the striking path and the plane in which the cooling liquid applicator 13 rotates,
3) the rotational velocity of the cooling liquid applicator 13 since this parameter controls which radial velocity components that will be provided to the stream that is ejected from the nozzle 15, and
4) the flow rate of the cooling liquid when being ejected from the nozzle 15 since this parameter controls which axial velocity component that will be provided to the stream.

Of these parameters the parameters 1 and 2 are design parameters that are given by the shaping and placement of the cooling liquid applicators 13 whislt the parameters 3 and 4 are variable and to a certain extent controllable by means of control of the cooling device. The design parameters 1 and 2 are suitably selected so that the striking path of the cooling liquid extends substantially straight across the coil ends 8 of the stator upon when the electric motor operating at a suitable speed and the cooling liquid being at a suitable liquid pressure. The stream of cooling liquid will thereby directly or indirectly strike the areas of the electric motor having the highest need for cooling, at least when the electric motor 1 operates within speed range intended for the electric motor.

Each cooling liquid applicator 13 is advantageously arranged to receive cooling liquid via said hub portion 17 so as to by means of the pressure of the cooling liquid and/or the centrifugal force caused by rotation of the cooling liquid applicator via an internal cooling liquid conduit (not shown) channel the cooling liquid through said arm portion 16 to the nozzle 15, from where it is ejected towards the end portion 7A of the stator through an outlet opening 39 in said nozzle 15.

In the illustrated embodiment the rotor shaft 6 comprises a cooling liquid conduit 18 arranged to channel the cooling liquid to the respective cooling liquid applicator 13 and up to its hub portion 17 through outlet 19 for cooling liquid arranged in the envelope surface of the rotor shaft. Each cooling liquid applicator 13 is attached to the rotor shaft 6 around one or more such cooling liquid outlets 19 so that the cooling liquid conduit 18 of the rotor shaft and the above mentioned interior cooling liquid conduit of the cooling liquid applicator 13 is brought into fluidic communication with each other. A seal 27, for example in the form of an O-ring, is advantageously mounted between the cooling liquid applicator 13 and the rotor shaft 6 so as to prevent leakage of cooling liquid in the joint there in between. The hub portion 17 of the cooling liquid applicator thereby comprises a substantially plane inner surface facing the rotor shaft 6 and comprises one or more cooling liquid inlets (not shown) arranged to be put in fluidic connection with said cooling liquid outlet 19 of the envelope surface of the rotor in order to channel cooling liquid via the interior cooling liquid conduit of the cooling liquid applicator from the rotor shaft to the nozzle 15 of the cooling liquid applicator.

FIG. 3A shows a variant of the first embodiment of the cooling device according to the present invention, according to which the cooling device is arranged to be supplied with cooling liquid that is channelled into the interior cooling liquid conduit 18 of the rotor shaft from an end 20 of the rotor shaft 6. Said rotor shaft end 20 extends through an end wall portion 9A of the motor housing 9 and ends just outside of the end wall portion 9A inside a cooling liquid container 21 applied exteriorly to the end wall portion 9A. Said rotor shaft end 20 further comprises an inlet opening 22A through which pressurized cooling liquid of said cooling liquid container 21 is fed into the rotor shaft 6 and its interior cooling liquid conduit 18 for further distribution to at least one and preferably all cooling liquid applicators 13 comprised in the cooling device.

In the exemplified embodiment the cooling liquid is channelled into the interior cooling liquid conduit 18 of the rotor via one and only end of the rotor shaft 6, located at one side of the electric motor 1 and its rotor/stator module and thus adjacent a first of the two opposing cooling liquid applicators 13. The cooling liquid is then channelled to the second and oppositely located cooling liquid applicator via a central portion 18A of said cooling liquid conduit 18, which extends axially interiorly of the rotor shaft 6 from one side of the stator/rotor module to the other side, through the rotor 5.

FIG. 3B show another variant of the first embodiment of the cooling device of the invention, which differs from the variant in FIG. 3A in that the cooling device in FIG. 3B is fed with cooling liquid channelled into the interior cooling liquid conduit 18 of the rotor shaft from at least one inlet opening 22B arranged in the envelope surface 22B of the rotor shaft. An advantage of supplying cooling liquid through an inlet of the envelope surface of the rotor shaft instead of through the rotor shaft end 20 is that it enable use of a double sided rotor shaft 6 that may be used for transferring torque to components coupled to both ends of the rotor shaft 6 extending from the motor housing 9.

Also in this embodiment the interior cooling liquid conduit 18 of the rotor shaft 6 comprises a central portion 18A extending axially along the rotor shaft, from one side of the rotor/stator module to the other side, through the rotor 5, so as to channel cooling liquid to the cooling liquid applicator 13 located on the opposite side of the rotor/stator module. In other embodiments (not shown) in which cooling liquid is supplied to the cooling liquid applicators 13 via inlets of the envelope surface of the rotor shaft such inlets may be arranged on both and opposite sides of the electric motor and its rotor/stator module, whereby the cooling liquid applicators 13 can be provided cooling liquid from more adjacently arranged inlets being arranged on the same side of the rotor/stator module as the respective cooling liquid applicator 13, which eliminates the need of the interiorly of the electric motor channel cooling liquid from one side of the rotor/stator module to the other side and which thus eliminates the need of the portion 18A, of the cooling liquid conduit 18, extending axially and interiorly of the rotor 5.

With continued reference to FIG. 3A the cooling device according to the invention further comprises a liquid cooling circuit comprising a pump unit 23 arranged to supply pressurised cooling liquid to the cooling liquid applicators 13 by means of a pump 24 comprised in the pump unit. In some embodiments the pump 24 is arranged to generate a substantially constant pressure of the cooling liquid and thereby a substantially constant outflow of the cooling liquid 14 being ejected from the cooling liquid applicators 13 towards the end portions 7A of the stator. In other embodiments the cooling device may comprise a control unit 25 that controls the pump in order to adapt the outflow of cooling liquid 14 based on different control parameters, which control parameters in FIG. 3A are symbolised by an arrow 26. For example the control unit 25 may be arranged to control the outflow of cooling liquid from the cooling liquid applicators based on one or more control parameters comprising the speed of the electric motor and/or at least a temperature indication indicative for the temperature of the electric motor or components thereof. As illustrated in FIG. 3A the control unit 25 may be comprised in the pump unit 23. In other embodiments the pump 24 may be controlled by at least one, in relation to the pump unit 23, externally arranged control unit to which the pump unit 23 is coupled.

The cooling device is further arranged for re-cycling of the cooling liquid that has been flushed by the cooling liquid applicators onto the components of the electric motor for the purpose of cooling these. Thereby the cooling device may comprise a cooling liquid tray 27 or other gathering device for collection of the cooling liquid that has been flushed onto the motor components and a cooling liquid conduit 29 in order to via the pump unit 23 transport the cooling liquid back to the cooling liquid applicators 13 for subsequent flushing onto the components of the electric motor.

For efficient cooling of the cooling liquid and the components onto which it is flushed the cooling device advantageously comprises a cooler 31 arranged to cool the cooling liquid prior to its use, i.e. after it has been collected following having been flushed onto the motor components from the cooling liquid applicators 13 and before it has been re-supplied to the cooling liquid applicators for subsequent ejection. The cooler 31 is generally arranged interiorly of the motor housing 9 and may in some embodiments be comprised in the pump unit 23 in order to thereby constitute a combined pump and cooling component that in a space conservative manner may be installed along the cooling liquid conduit 29. Coolers for cooling of cooling liquid are well known within the technical field and the cooler 31 may be configured and structured for cooling of the cooling liquid according to any known principles for liquid cooling.

In the variant of the cooling device that is shown in FIG. 3B, in which the electric motor 1 comprises a rotor shaft 6 provided with a cooling liquid inlet 22B along its envelope surface, the cooling device further comprises a device 33, hereinafter referred to as cooling liquid distributor, which is arranged to distribute cooling liquid along the circumference of the rotor shaft so as to ensure that the or those (in the event of several) cooling liquid inlets 22B being arranged along the envelope surface of the rotor shaft and thereby rotates with it, constantly can be provided with cooling liquid independent from the current position of the rotor 5 and the rotor shaft 6. The cooling liquid distributor 33 is arranged stationary and comprises a sealing configuration 35 which provides a sealing between cooling liquid distributor 33 and the rotor shaft 6 whilst it thus allows the rotor shaft 6 to rotate in relation to the stationary cooling liquid distributor 33. The cooling liquid distributor 33 configured so that the pressurised cooling liquid that is received from the pump unit 23 is gathered in a ring shaped space 37 along the circumference of the rotor shaft in order to ensure that cooling liquid continuously into the inlet 22B to cooling liquid conduit 18 interior of the rotor shaft when the inlet rotates along the inner circumference of the ring shaped space with a rotational velocity corresponding to the speed of the electric motor. In the exemplified embodiment shown in FIG. 3B the cooling liquid distributor 33 is fixedly attached to the end wall 9A of the motor housing. It shall be realised that the cooling liquid distributor 33 may constitute an integrated portion of the motor housing 9, for example its end wall 9A, or be a separate component that is arranged around the circumference of the rotor shaft and that is made stationary by means of being fixedly attached to the motor housing 9 or other suitable components of the motor or in its immediate vicinity.

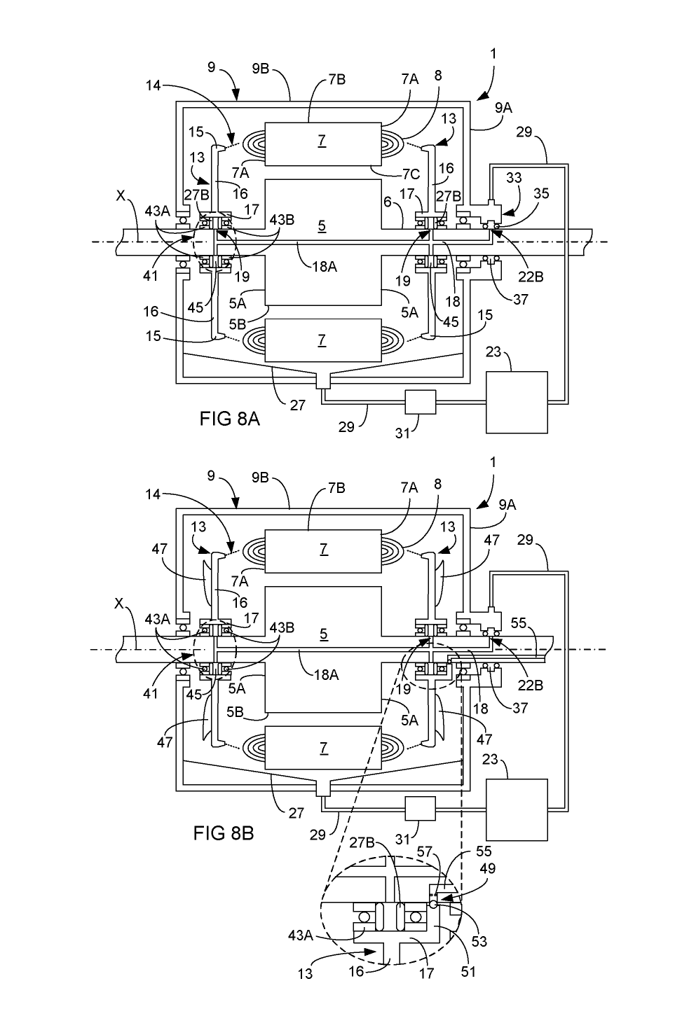

FIGS. 8A and 8B schematically illustrates a side view of an axial cross section of an electric motor 1 having a device for liquid cooling of the electric motor according to a second embodiment of the present invention. The cooling device and its components is substantially similar to the cooling device and its components illustrated in FIG. 3A and FIG. 3B. A substantial difference is however the configuration of the cooling liquid applicators and the way in which they are caused to rotate relative to the stator 7 and its end portions 7A.

Like the cooling liquid applicators in the first embodiment the cooling liquid applicators 13 in this second embodiment are arranged to be caused to move by means of the rotation of the rotor shaft, but unlike therefrom the cooling liquid applicators 13 is here rotatably arranged relative to the rotor shaft 6 so that the rotational velocity of the cooling liquid applicators not necessarily need to correspond to the rotational velocity of the rotor and the rotational velocity of the rotor shaft, alike the speed of the motor.

This is accomplished by means of allowing each cooling liquid applicator 13 to be mounted rotatably journaled in bearing to the rotor shaft 6 by means of a bearing configuration 41, for example comprising ball bearings 43A-B intermediate between the cooling liquid applicator 13 and the rotor shaft 6. In the exemplified embodiments shown in FIGS. 8A and 8B two ball bearings 43A-B are arranged interiorly of the hub portion 17 of the cooling liquid applicator, between the hub portion and the rotor shaft 6, wherein the outer bearing rings of the ball bearings coupled to the above mentioned inner surface of the hub portion 17 and the inner bearing rings of the ball bearings are coupled to the envelope surface of the rotor shaft. The bearing configuration 41 further comprises a sealing configuration 27B in order to create a sealed fluidic connection between the cooling liquid outlets 19 of the envelope surface of the rotor shaft and the cooling liquid inlet (not shown) of the cooling liquid applicator 13, which channels the cooling liquid into its interior cooling liquid conduit for further transport up to the nozzle 15. Since the hub portion 17 and the rotor shaft 6 are rotatable relative to each other the sealing configuration 27B, in similar with the sealing configuration 35 in FIG. 3B, is configured to form a ring shaped space 45 along the circumference of the rotor shaft, between the envelope surface of the rotor shaft and said inner surface of the hub portion 17, in which cooling liquid can accumulate so that it may always flow into the cooling liquid inlet of the hub portion independent from the relative position between the hub portion 17 and the rotor shaft 6 and thereby between the cooling liquid outlets 19 of the rotor shaft and the cooling liquid inlets of the hub portion 17 of the cooling liquid applicators. Although the illustrated rotor shaft 6 is provided with two oppositely located cooling liquid outlets 19 (of which only one is provided with a reference numeral) for channelling of cooling liquid out into the ring shaped space 45 it should be realised that such a cooling liquid outlet is sufficient for ensuring the above described functionality.

In this embodiment the cooling liquid applicators 13 is caused to move relative to the stator 7 by means of the action of friction arising via the intermediate bearing configuration 41between the rotor shaft 6 and the cooling liquid applicator 13. When the rotor 5 rotates and the rotor shaft 6 thereby is caused to rotate this will cause a rotation in the same direction of rotation also in the cooling liquid applicator 13. The cooling liquid applicator 13 is thus caused to rotate by means of frictional action between the cooling liquid applicator 13 and the rotor 6 despite that these by means of the intermediate bearing configuration are rotatably arranged relative to each other.

The rotational velocity of the cooling liquid applicator 13 and thereby the striking path of the cooling liquid will be controlled by a plurality of parameters, there amongst the characteristics of the bearing configuration 41 and the rotational velocity of the rotor shaft, i.e. the speed of the electric motor. With reference to FIG. 8B which shows a number of possible constructional details, which for the reason of limited space is not shown in FIG. 8A, the cooling liquid applicators 13 may be provided with elements 47, hereinafter referred to as fan blades, for reducing the rotational velocity of the cooling liquid applicators 13 at high speed and/or for creation of increased turbulence inside the motor housing 9 thereby additionally improve the cooling od the electric motor 1 and its components. For the latter mentioned purpose such fan blades may also be advantageous for the first embodiment described above with reference to FIGS. 3A and 3B.

The fan blades 47 are configured to increase the surface of the cooling liquid applicators 13 in a direction across the rotational direction of the cooling liquid applicators 13 so as to generate an increase air resistance upon rotation thereof. As easily apprehended by the skilled person the fan blades may be configured in many different ways and have an appearance largely deviating from the fan blades 47 exemplified in FIG. 8B. In particular the fan blades 47 are configured so as to increase the air resistance upon rotation of the cooling liquid applicators 13 is such a manner that the rotational velocity of the cooling liquid applicators is below the rotational velocity of the rotor shaft. In particular the fan blades 47 are configured to reduce the rotational velocity of the cooling liquid applicators relative to the rotational velocity of the rotor shaft upon high speeds.

In order further control the rotational velocity of the cooling liquid applicators and increase or decrease this in relation to the rotational velocity of th rotor the cooling liquid applicator 13A may further be arranged to eject the cooling liquid in a direction that has an accelerating or de-accelerating effect on the rotational movement of the cooling liquid applicator, i.e. in a direction obliquely forwards or obliquely backwards in the rotational direction of the cooling liquid applicators. By this is meant that the direction in which the cooling liquid applicator ejects the cooling liquid is not orthogonal to the plane in which the cooling liquid applicator 13 rotates instead it has a directional component in tangential direction of the path along which the cooling liquid applicator 13 rotates.

By means of for example providing the cooling liquid applicator 13 with one or more nozzles configured to eject the cooling liquid in a direction obliquely forwards in the rotational direction of the cooling liquid applicator, given by the rotational direction of the rotor shaft, the rotational velocity of the cooling liquid applicator can be reduced based on the braking force that effects the cooling liquid applicator when it ejects cooling liquid with a certain momentum in a direction opposite to the movement direction.

The braking or accelerating force acting on the cooling liquid applicator 13, caused by the obliquely ejected flow, is at least partly dependent on the outflow with which cooling liquid is ejected from the cooling liquid applicator, and the direction in which it is ejected. According to an embodiment a control unit comprised in the cooling device, such as control unit 25 illustrated in FIG. 3A, is configured to control said outflow and/or direction of ejection, so as to thereby control the rotational velocity of the cooling liquid applicators 13 of the cooling device.

The control unit 25 may be configured to control said outflow by means of controlling the pressure of the cooling liquid that is to be ejected by the cooling liquid applicators 13. For example the control unit 25 may be configured to achieve a desired pressure on the cooling liquid down streams of the pump unit 23 and thereby a desired outflow of the cooling liquid that is to be ejected by the cooling liquid applicators 13. Thereby the cooling device may comprise at least one pressure sensor (not shown) for sensing the pressure of the cooling liquid in the pressure conduit 23, before this is ejected from the cooling liquid applicators 13, whereby said pressure sensor is coupled to the control unit 25 for control of the pump 24 based on thereof collected pressure data.

In order to eject the cooling liquid in said oblique direction the interior cooling liquid conduit of the cooling liquid applicators and/or the outlet opening 39 may be arranged for ejection of the cooling liquid in an oblique and predetermined direction. This may for example be achieved by means of providing the cooling liquid applicators with one or more canted nozzles arranged to eject cooling liquid in said predetermined and oblique direction. An example of cooling liquid applicators 13 of this type with canted nozzles 14A is illustrated in FIG. 5.

Further, as an addition to or instead of said pressure based control of the rotational velocity of the cooling liquid applicators, the cooling device may according to the invention comprise an ejection direction device arranged to control the rotational velocity of the cooling liquid applicators by means of controlling the direction in which the cooling liquid is ejected from the cooling liquid applicator.

The ejection direction device may comprise controllable directional means that controls the direction in which the flow of cooling liquid is ejected from the cooling liquid applicators and a control unit for controlling said directional means in order to achieve a desired rotational velocity of the cooling liquid applicators 13. With reference to the exemplified embodiment of a cooling liquid applicator 13 in FIG. 6 such a directional means may comprise a least one pivotable nozzle 15B which is pivotable in such a manner that the direction in which the cooling liquid is ejected can be varied. That the direction can be varied here means that the directional components of the direction of the ejection coinciding with rotational direction of the cooling liquid applicator can be varied in size so as to thereby vary the accelerating or de-accelerating force acting on the rotational movement of the cooling liquid applicator. The cooling liquid applicator 13 comprising such a pivotable nozzle 15B may further comprise a device, such as an electric motor, for accomplishing said rotation of the nozzle 15B. The electric motor may according to an embodiment be coupled to said control unit, whereby the control unit controls the electric motor so as to adjust the position of the nozzle 15B and thereby the direction of the ejection so as to achieve desired rotational velocity of the cooling liquid applicators 13, and thus desired striking path of the cooling liquid that is ejected towards the end portions 7A and coil ends 8 of the stator. The nozzle 15B is in this exemplified embodiment shown as rotatably mounted journaled in bearing to the arm portion 16 of the cooling liquid applicator along a joint 48 across a longitudinal direction of the arm portion, meaning that the nozzle 15B is pivotable around an axis substantially coinciding or at least substantially parallel with main direction of extension of the arm portion.

In another embodiment illustrated in FIG. 7 the cooling liquid applicator 13 comprises an ejection direction device whose directional means comprises at least one direction blade 42 or similar components arranged in the flow path of the cooling liquid, by the outlet 39 of the nozzle 15C, so as to thereby control the direction of the ejected cooling liquid flow. Also in this case the ejection direction device may comprise an electric motor or other device for adjustment of the position of the direction blade 42, whereby this device is coupled to and controlled by a control unit comprised in the cooling device for control of the direction in which the cooling liquid flow is ejected and thereby the rotational velocity of the cooling liquid applicator 13. This embodiment with adjustable direction blades 42 in the outlet 39 of the nozzle may naturally be combined with the embodiment having a pivotable nozzle 15B, as described above with reference to FIG. 6.

Although the above described embodiments aims to control the rotational velocity of the cooling liquid applicators relative to the rotational velocity of the rotor shaft it may for some situations, for example at relatively low electric motor speeds, be desirable to allow the cooling liquid applicators to rotate with the same velocity as the rotor shaft 6. With continued reference to FIG. 8B the cooling device may therefore comprise a locking mechanism 49 configured to prevent rotation of the cooling liquid applicator 13 relative to the rotor shaft 6.The locking mechanism may be configured to lock the cooling liquid applicator 13 to the rotor shaft 6 and in this manner force the cooling liquid applicator 13 to rotate with the same velocity as the rotor shaft 6. For example the cooling liquid applicator 13 may comprise a part configured to be causes to grip the a part of the rotor shaft 6, so as to thereby lock the cooling liquid applicator 13 to the rotor shaft 6 so that relative rotation there in between is prevented.

In the exemplified embodiment illustrated in FIG. 8B said part 51 is constituted by a lip element 51 of the hub portion 17 of the cooling liquid applicator 13, which lip element 51 extends in direction towards the rotor shaft 6 so as to rotate along the envelope surface of the rotor shaft upon relative rotation between the cooling liquid applicator 13 and the rotor shaft 6. The lip element 51 comprises a surface facing the rotor shaft 6, which surface comprises an aperture configured to receive partly accommodate a locking ball 53. In non-locked, i.e. when the cooling liquid applicator 13 is allowed to rotate relative to the rotor shaft 6, the locking ball 53 is sunk in a space of the rotor shaft 6 from where it may be caused to partly protrude in order to grip into said aperture of the lip portion 51 of the cooling liquid applicator so as to thereby allow to lock the cooling liquid applicator 13 to the rotor shaft 6. The space wherein the locking ball rests in the non-locked position comprises a conduit 55 for oil, which oil conduit 55 comprises a ball support 57 onto which the locking ball 53 rests when said oil conduit 55 is not pressurised. In the exemplified embodiment the cooling liquid applicator 13 may thus be locked to the rotor shaft 6 so as to prevent relative rotation between the cooling liquid applicator 13 and the rotor shaft 6 by means of pressurising the oil, or increasing the pressure of the oil, in the oil conduit 55, whereby the oil pressure causes the locking ball 53 to protrude from the envelope surface of the rotor shaft and grip an aperture of the lip element 53 of the cooling liquid applicator. The oil in the oil conduit 55 may for example be comprised of hydraulic oil or oil used as cooling liquid 14 for cooling of the electric motor 1.

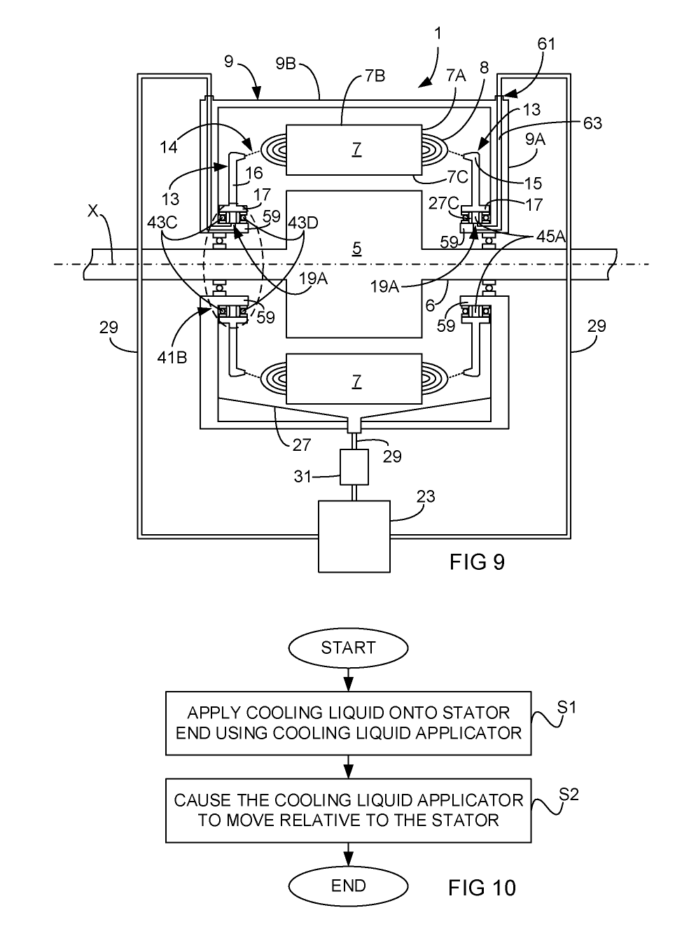

FIG. 9 schematically illustrates a side view of an axial cross section of an electric motor having a cooling device for liquid cooling of the electric motor 1 according to a third embodiment of the present invention. The cooling device and its components are substantially similar to the cooling device and the components of the first and second embodiments illustrated in FIGS. 3A and 3B respectively FIGS. 8A and 8B. A substantial difference is however the configuration of the cooling liquid applicators and the way in which they are caused to rotate relative to the stator 7 and its end portions 7A.

Unlike the cooling liquid applicators of the first and second embodiment the cooling liquid applicators 13 in this third embodiment are not arranged to be caused to rotate by means of rotational movement of the rotor shaft. Instead the cooling liquid applicators 13 in this embodiment are arranged to be caused to rotate relative to the stator 7 solely by means of the recoil which they are exposed to during ejection of cooling liquid.

Each cooling liquid applicator 13 is thereby configured to eject cooling liquid in a direction obliquely forwards and/or obliquely backwards in the rotational direction of the cooling liquid applicator. As has been described above this causes an accelerating of de-accelerating force acting on the cooling liquid applicator 13 upon ejection of cooling liquid, whereby the rotational velocity, if so desired or required, may be controlled by means of controlling the flow of the ejection and/or the direction of the ejection of the cooling liquid in a similar fashion and with similar means as described above. Thereby the cooling liquid applicators 13 may be configured in accordance with any of the cooling liquid applicators 13 of FIGS. 5-7, which thus means that the cooling liquid applicators 13 may be configured to eject cooling liquid with a predetermined and constant angle (FIG. 5), or they may be provided with pivotable nozzles 15B (FIG. 6) and/or with nozzles having adjustable direction blades 42 (FIG. 7) for adjustment of the direction in which the cooling liquid is ejected. Furthermore, the cooling device may thus be arranged to control the rotational velocity of the cooling liquid applicators by means of control of the flow of the ejection, whereby the cooling device for example may comprise a control unit 23 (see FIG. 3A) controlling a cooling liquid pump 24 based on a monitored cooling liquid pressure so that a desired pressure and thereby a desired flow of the ejection can be achieved.

The cooling liquid applicators 13 of this embodiment are arranged independently and separately from relative to the rotor shaft 6 of the rotor 5 of the electric motor and do not in any way use the rotation of the rotor for generation of own movement relative to the end portion of the stator 7A. The cooling liquid applicators 13 are not mechanically coupled to the rotor 5 or the rotor shaft 6 but are instead mounted journaled in bearing to components being stationary relative to the stator 7.

In the exemplified embodiment shown in FIG. 9 each cooling liquid applicator is rotatably mounted journaled in bearings to a portion of the motor housing 9. In more detail each cooling liquid applicator 13 is rotatably mounted journaled in bearing to an end wall 9A of the motor housing. The cooling liquid applicator 13 is mounted journaled in bearings to the end wall 9A so that the cooling liquid applicator is allowed to rotate in a plane located interiorly of and substantially parallel with the end wall 9A of the motor housing. For example the cooling liquid applicators may be rotatably arranged on a circular and preferably ring shaped lip 59 of said end wall, whereby the lip 59 extends substantially perpendicularly from said end wall 9A, in towards the centre of the motor housing. Thereby, the cooling liquid applicator 13 is arranged to rotate in a plane substantially parallel with the end portion 7A of the stator, being intermediate between said end wall 9A of the motor housing and said end portion 7A of the stator 7.

The circular lip 59 is advantageously arranged concentrically with the rotor shaft 6. Furthermore, the circular lip 59 is thus advantageously ring shaped, whereby the rotor shaft 6 may be arranged to extend through said ring shaped lip and further out through the end wall 9A from which the lip extends into the motor housing, so as to thereby constitute an outgoing drive shaft of the electric motor 1 and its motor housing 9. As shown in FIG. 9 the electric motor advantageously may comprise two such ring shaped lips 59, arranged on a respective axial side of the rotor/stator module and each supporting a respective cooling liquid applicator 13, which enable use of a double sided rotor shaft 6 extending from both sides of the electric motor 1.

The cooling liquid applicator 13 is advantageously mounted journaled in bearings to the ring shaped lip 59 in a similar fashion as the cooling liquid applicator in mounted journaled in bearings to the rotor shaft 6 in the second embodiment of the cooling device according to the invention, described above with reference to FIGS. 8A and 8B. This means that each cooling liquid applicator 13 is rotatably mounted journaled in bearings to said lip 59 by means of a bearing configuration 41B, for example comprising ball bearings 43C-D. The bearing configuration 41B further comprises a sealing configuration 27C for creating a sealed flow connection between a cooling liquid outlet 19A of the lip 59 and the cooling liquid inlet (not shown) of the cooling liquid applicator 13, which channels the cooling liquid into the interior cooling liquid conduit (not shown) of the cooling liquid applicator 13 for subsequent transport up to the nozzle 15. Since the hub portion 17 of the cooling liquid applicator 13 is rotatable relative to the lip 59 the sealing configuration 27C is configured to form a ring shaped space 45A along the circular circumference of the lip, between the envelope surface of the lip and the inner surface of the hub portion 17 facing the lip 59, whereby cooling liquid may accumulate in said ring shaped space 45A so that it always is able to flow into the cooling liquid inlet of the hub portion independent of the relative position between the hub portion 17 and the lip 59 and thereby between the cooling liquid outlets 19A of the lip 59 and the cooling liquid inlets of the hub portion 17.

The end wall 9A of the motor housing is here seen comprising a cooling liquid inlet 61 and an interior cooling liquid conduit 63 for supply of cooling liquid to the cooling liquid applicator 13 via said cooling liquid outlet 19A of the lip 59 around which the hub portion 17 of the cooling liquid applicator is applied. In the illustrated embodiment each end wall 9A of the motor housing 9 comprises a respective inlet 61 for receiving of cooling liquid from the pump unit 23 of the cooling device via a respective cooling liquid conduit 29. In other embodiments the motor housing 9 may comprise a single cooling liquid inlet for receiving of cooling liquid from the pump unit 23, whereby each cooling liquid applicator 13 comprised in the cooling device may be provided with cooling liquid from said single cooling liquid inlet. In order to transport cooling liquid to the respective end wall portion 9A of the motor housing 9 and further to the cooling liquid outlets 19A in the respective lip portion 59 such embodiment generally requires that one or more interior cooling liquid conduits also are in the envelope walls 9B of the motor housing.

In an additional embodiment (not shown) the cooling liquid applicators 13 may be arranged to be caused to move by means of a power source comprised in the device for electrical operation of said cooling liquid applicators 13. Thus, according to this embodiment, neither the movement of the rotor shaft nor the recoil resulting from ejection of cooling liquid is needed for causing the cooling liquid applicators 13 to move relative to the stator 7. For example such embodiment may be substantially similar to the device of FIG. 9, with the difference that a power source (not shown) in a suitable fashion is arranged to operate the cooling liquid applicator 13 to cause rotation around the extending lip portion 59 of the end wall 9A of the motor housing. According to a variant the power source may be constituted by a generator comprised in the device, configured to convert a portion of the mechanical energy of the rotor shaft into electrical energy with which the generator causes the cooling liquid applicators 13 to move.

FIG. 10 is a flow diagram illustrating a method for liquid cooling of an electric motor according to the above described principles.

In a first step, S1, cooling liquid is applied onto the stator and at least onto one of its end portions 7A. As has been described in more detail above cooling liquid is applied from one side of the stator by means of at least one cooling liquid applicator 13.

In a second step, S2, said at least one cooling liquid applicator 13 is caused to move, typically rotational movement, relative to said stator 7 and the end portion 7A onto which cooling liquid is to be applied, whereby the cooling liquid is applied onto different areas of said end portion 7A.

Whether the application of cooling liquid onto the stator and its end portions beings just before or after the cooling liquid applicator is caused to move relative to the stator is not an important factor. As apprehended by the skilled person in the light of the description above it is important that the cooling liquid applicator is not held stationary relative to the stator during too long periods of time so as to avoid erosion of motor components in general and in particular the coil ends of the stator. It should thus be realised that the steps S1 and S2 may be performed in any to each other relative sequence but that step 1 for achieving the best effect should be started simultaneously with, after, or at least not too long after step S2 is started.

1. A device for liquid cooling an electric motor having a rotor and a stator, comprising:
a cooling liquid applicator arranged to apply cooling liquid from a side of said stator onto an end portion of said stator, wherein said cooling liquid applicator is moveably arranged relative to said stator so that the cooling liquid based on movement of the cooling liquid applicator is applied onto different areas of said end portion.

2. The device according to claim 1, wherein said cooling liquid applicator is arranged at the side of the stator in its axial direction of extension and configured to eject cooling liquid in direction towards said end portion.

3. The device according to claim 1, wherein said cooling liquid applicator is rotatably arranged relative to said stator.

4. The device according to claim 3, wherein said cooling liquid applicator is configured to eject the cooling liquid during rotation relative to said stator along a substantially circular path in a plane located at a distance from and substantially parallel with said end portion of the stator.

5. The device according claim 3, wherein said cooling liquid applicator is arranged to rotate along an axis substantially coinciding with a rotor shaft of the electric motor.

6. The device according to claim 3, wherein said cooling liquid applicator is arranged to be caused to rotate based on a rotational movement of said rotor.

7. The device according to claim 6, wherein the cooling liquid applicator is fixedly mounted to a rotor shaft coupled to the rotor.

8. The device according to claim 7, wherein the cooling liquid applicator based on a bearing configuration is rotatably mounted journaled in bearings to a rotor shaft coupled to the rotor so that the cooling liquid applicator is caused to rotate due to friction action between the rotor shaft and the cooling liquid applicator.

9. The device according to claim 8, wherein the cooling liquid applicator comprises a fan blade arranged to increase the air resistance when the cooling liquid applicator is caused to rotate, so as to reduce a rotational velocity of the cooling liquid applicator relative to a rotational velocity of the rotor shaft.

10. The device according to claim 8, further comprising a locking mechanism for preventing relative rotation between the cooling liquid applicator and the rotor shaft and thereby causing the cooling liquid applicator to rotate with the same rotational velocity as the rotor shaft.

11. The device according to claim 3, wherein the cooling liquid applicator is arranged to eject the cooling liquid in a direction obliquely forwards and/or backwards in a rotational direction of the cooling liquid applicator in order to, based on thereby arising de-accelerating and/or accelerating force affect the rotational velocity of the cooling liquid applicator.

12. The device according to claim 11, further comprising a control unit (23) for controlling a flow with which the cooling liquid is ejected from the cooling liquid applicator, so as to control the rotational velocity of the said cooling liquid applicator.

13. The device according to claim 11, wherein the cooling liquid applicator based on a bearing configuration is rotatably mounted journaled in bearings to a component being stationary relative to the stator, wherein the cooling liquid applicator is arranged to be caused to rotate at least partly by ejection of cooling liquid in a direction obliquely backwards in the rotational direction of the cooling liquid applicator.

14. The device according to claim 1, comprising at least two cooling liquid applicators arranged on opposite sides of said stator and configured to apply the cooling liquid onto opposite ends of said stator.

15. The device according to claim 1, wherein said cooling liquid applicator comprises a substantially circular hub portion configured to be caused to rotate around an axis (X) substantially coinciding with a rotor shaft of the electric motor, and a plurality of arm portions extending radially from said hub portion, wherein each arm portion supports a nozzle for ejection of the cooling liquid, arranged in the opposite end of the arm portion being distant from the hub portion.

16. The device according to claim 3, comprising an ejection direction device configured for control of a direction in which the cooling liquid is ejected from the cooling liquid applicator, so as to thereby control a rotational velocity of the cooling liquid applicator.

17. The device according to claim 1, wherein the cooling liquid applicator is arranged to apply the cooling liquid onto said end portion in a form of a substantially continuous stream.

18. An electric motor comprising the device according to claim 1.

19. A motor vehicle comprising the electric motor according to claim 18.

20. A method for liquid cooling an electric motor having a rotor and a stator, comprising the steps of:
from a side of said stator applying (S1) cooling liquid onto at least one end portion of said stator using at least one cooling liquid applicator,
during application of the cooling liquid causing (S2) said cooling liquid applicator to move relative to said stator so that the cooling liquid is applied onto different areas of said end portion.

21. The method according to claim 20, wherein the application of the cooling liquid is performed by ejecting the cooling liquid towards said end portion using the cooling liquid applicator arranged at the side of the stator in its axial direction of extension.

22. The method according to claim 21, comprising the step of causing the cooling liquid applicator to move in a rotational movement relative to said stator.

23. The method according to claim 22, comprising the step of ejecting cooling liquid towards said end portion along a substantially circular path in a plane located at a distance from and substantially parallel with said end portion of the stator.

24. The method according to claim 22, comprising the step of causing the cooling liquid applicator to move in a rotational movement around an axis substantially coinciding with a rotor shaft of the electric motor.

25. The method according to any of claim 22, comprising the step of causing said cooling liquid applicator to rotate based on a rotational movement of said rotor.

26. The method according to claim 25, wherein the cooling liquid applicator is fixedly mounted to a rotor shaft coupled to the rotor and wherein the cooling liquid applicator is caused to rotate by rotation of said rotor shaft.

27. The method according to claim 22, wherein the cooling liquid applicator based on a bearing configuration is rotatably mounted journaled in bearings to a rotor shaft coupled to the rotor and wherein the cooling liquid applicator is caused to rotate by a friction action between the rotor shaft and the cooling liquid applicator.

28. The method according to claim 20, wherein application of cooling liquid is achieved by when the cooling liquid applicator ejects the cooling liquid in a direction obliquely forwards and/or backwards in a rotational direction of the cooling liquid applicator so as to, based on thereby arising de-accelerating and/or accelerating force affect a rotational velocity of the cooling liquid applicator.

29. The method according to claim 28, further comprising the step of controlling a flow with which the cooling liquid is ejected from the cooling liquid applicator so as to control the rotational velocity of the cooling liquid applicator.

30. The method according to claim 28, wherein the cooling liquid applicator based on a bearing configuration is rotatably mounted journaled in bearings to a component being stationary relative to the stator, comprising the step of causing the cooling liquid applicator to rotate at least partly by ejecting the cooling liquid in a direction obliquely backwards in the rotational direction of the cooling liquid applicator.
